(19) United States
(12) Patent Application Publication
(10) Pub. No.: US 2025/0258013 A1
(43) Pub. Date: Aug. 14, 2025

(54) METHOD AND SYSTEM FOR PROVIDING MAP DATA FOR THE OPERATION OF AN AUTOMATED AND/OR ASSISTING SYSTEM

(71) Applicant: Robert Bosch GmbH, Stuttgart (DE)

(72) Inventors: Max Kirstein, Hohenhameln - Ot Bruendeln (DE); Andre Wagner, Hannover (DE); Hans-Georg Raumer, Hildesheim (DE); Peter Engel, Hessisch Oldendorf (DE); Thomas Wenzel, Hamburg (DE); Thorben Funke, Sarstedt (DE)

(21) Appl. No.: 19/034,688

(22) Filed: Jan. 23, 2025

(30) Foreign Application Priority Data
Feb. 12, 2024 (DE) 10 2024 201 245.9

(51) Int. Cl. G01C 21/00

(52) U.S. Cl. CPC G01C 21/3859; G01C 21/3841

(57) ABSTRACT

A method for creating map data for the operation of an automated and/or assisting system of a vehicle or robot. A map for a traffic route portion of a traffic route is compared with a reference map for the traffic route portion on an automated basis. The map is used exclusively for creating the map data on an automated basis when the map does not deviate from the reference map by a predefined extent with regard to at least one predefined quality measure.

### CROSS REFERENCE

The present application claims the benefit under 35 U.S.C. § 119 of German Patent Application No. DE 10 2024 201 245.9 filed on Feb. 12, 2024, which is expressly incorporated herein by reference in its entirety.

### FIELD

The present invention relates to a method for providing map data for the operation of an automated and/or assisting system of a vehicle or robot. The present invention also relates to a system for providing map data for the operation of an automated and/or assisting system of a vehicle or robot.

### BACKGROUND INFORMATION

Maps that are used for self-localization of vehicles, so-called high-definition maps, form the basis for autonomous driving of vehicles in particular. Without such maps, it is significantly more difficult to navigate a vehicle in road traffic, since there is no basis for self-localization. Above all, the maps must demonstrate high accuracy and up-to-date information with respect to the position of road features, such as lane markings, road signs, etc.

The map is typically created on a fully automated basis using an algorithmic chain based on data from a fleet of vehicles already in use on the road, i.e., data obtained via crowd-sourcing by means of a fleet of vehicles. These data are subject to high levels of noise due to the vehicle sensors used to generate them. As a result, after the map is created, it is absolutely necessary to check its accuracy. Checking or verifying the accuracy of a map is currently a time-consuming manual process, which involves considerable financial and personnel expenditure.

U.S. Patent Application Publication No. US 2022/0341750 A1 describes monitoring a state of a high-definition map to be able to determine whether or not there is an inaccuracy in the map. If an inaccuracy is identified in the map that indicates a deterioration in the state of the map, updated data can be obtained through crowd-sourcing from one or more vehicles for the region of the map exhibiting the error, and the updated data can then be used to update, check and validate the map.

### SUMMARY

The subject matter of the present invention includes a method for creating map data for the operation of an automated and/or assisting system of a vehicle or robot, with which method a first automated accuracy check of a freshly generated map can be performed by comparing the map for a traffic route portion of a traffic route with a reference map for the traffic route portion in an automated, automatic or electronic process and exclusively using the map for creating the map data by means of automation if the map does not deviate from the reference map by a predefined extent with regard to at least one predefined quality measure. Due to this automation, the manual effort required to create map data can be reduced as far as possible. The accuracy of the map can be checked directly after the map is created, for example, in order to able to ensure the initial quality of the map data, as a result of which the map data quality is ultimately increased. The present invention is therefore used to initially ensure the quality of the map data and not to revise map data already in use.

The map contains spatially resolved or local map data, which can be given as a point cloud. Maps or local map data sets assigned to a specific traffic region can be combined with one another using a scan-matching method (also known as a map alignment method) in order to improve map accuracy or the up-to-date status of the map. Traditionally, an aligning transformation is ascertained between two local map data sets, which can originate from any sensors, such as lane markings or radar echoes recognized by a vehicle camera. This aligning transformation is usually a key first step in the processing of a plurality of partially overlapping local map data sets. Within the scope of the present application, such a local map data set is referred to as a map, which is compared with the corresponding reference map.

The present invention can be used to analyze data from a map that has been generated by at least one vehicle sensor. The vehicle sensor can be used, for example, for detecting a vehicle environment, wherein the map data are provided in the form of sensor signals, which can be provided, for example, as digital images such as video images, radar data, LiDAR data, ultrasonic data or motion data or as thermal images.

Road features can be displayed on maps by means of polylines or point clouds. The accuracy of a local map can thus be checked by comparing these structures with a local reference map parameterized in the same manner. This check of the map can be performed, for example, by means of a limit value of at least one quality measure, which can be specified in advance by the user. It possible, for example, to use the mean square error with a specific limit value. This limit value would then specify an upper bound for the tolerable local deviation of the map from the reference map. By means of heuristic limits for quality measures or error measures specified by the user, faulty areas of the map can be identified.

The map data generated by the method according to the present invention can be provided to an automated vehicle system (AD system) and/or an assisting vehicle system (DA system), as a result of which more accurate inputs are provided to the particular system so that the particular system can output more accurate outputs, i.e., has an improved function. This is in particular advantageous with regard to autonomous vehicle driving.

In an advantageous embodiment of the present invention, a warning signal is generated and output if the map deviates from the reference map by the predefined extent with regard to the predefined quality measure. If the map deviates from a corresponding feature of the reference map with regard to at least one feature contained in the map by the predefined extent or a predefined limit value, the user, in particular a developer who is processing the generated map, can be made aware of this at least one deviation region of the map by means of the perceptible warning signal. Subsequently, the map can be manually checked in a manner limited to this deviation region only, which is possible with significantly less personnel expenditure than the conventional process of carrying out a complete manual check of a map. Thus, this embodiment is particularly useful for the map development process.

According to a further advantageous embodiment of the present invention, the map is created using data obtained via crowd-sourcing by means of a fleet of vehicles. The map can be produced on the basis of crowd-sourced data using an algorithmic chain.

According to a further advantageous embodiment of the present invention, the reference map is created using sensor data obtained by means of a high-precision vehicle sensor system while driving along the traffic route portion. The reference map can thus be obtained on the basis of measurements from at least one vehicle with a high-precision environmental sensor system.

According to a further advantageous embodiment of the present invention, the map is exclusively used for creating the map data on an automated basis if a quality of the map fulfills at least one additional evaluation criterion. Whether the additional evaluation criterion is fulfilled or not can be checked, for example, by applying a plausibility check within a data layer of the map. For example, within the scope of a plausibility check, it can be checked whether a detected number of lanes and/or a detected lane width (within a predefined tolerance) and/or a detected distance between lane markings (within a predefined tolerance) and/or a detected relationship between different landmarks (for example, that traffic signs must not be located on a lane marking) are plausible. The additional evaluation criterion can, for example, be given as an error function in the form of a linear combination of various additional evaluation criteria, for example the various aforementioned additional evaluation criteria.

Alternatively or additively, the additional evaluation criterion can be obtained from information outside the data layer of the map. For example, as an additional evaluation criterion, it can be specified that a center line of a road correctly derived from lane markings may never run outside the road. This can then be checked within the scope of a plausibility check. A “behavior map” can provide an indication of an invalid lane marking if this lane marking is always ignored by a driver in accordance with the “behavior map.” As an additional evaluation criterion, the map can thus be checked for the presence of an invalid lane marking.

According to an example embodiment of the present invention, another way to implement an additional evaluation criterion is to use dimensions and/or values that are generated when the map data are created. For example, the extent of an error in a global pose optimization of local scan matchings can be used as an additional evaluation criterion. Alternatively or additively, the size of a ratio of the number of scan matches with low error to the total number of scan matches used can be used as an additional evaluation criterion. Alternatively or additively, an inconsistency measure of mutually overlapping map portions after a scan matching (“map is aligned, but not consistent at overlapping seams”) can be used as an additional evaluation criterion. Alternatively or additively, a number of necessary corrections during an optimization method can be used as an additional evaluation criterion.

A further subject matter of the present invention is a system for providing map data for the operation of an automated and/or assisting system of a vehicle or robot, wherein the system is configured to compare a map for a traffic route portion of a traffic route with a reference map for the traffic route portion and to exclusively use the map for creating the map data if the map does not deviate from the reference map by a predefined extent with regard to at least one predefined quality measure. Advantageously, according to an example embodiment of the present invention, the system is configured to perform the method according to one of the above-mentioned embodiments or a combination of at least two of these embodiments with one another.

The advantages mentioned above with reference to the method of the present invention are correspondingly associated with the system of the present invention. Advantageous embodiments of the method of the present invention may correspond to advantageous embodiments of the system of the present invention, even if this is not explicitly referred to below.

In the following, the present invention is explained by way of example with reference to the figures based on preferred example embodiments, wherein the features explained below can represent an advantageous and/or developing aspect of the present invention both individually and in different combinations of at least two of these features with one another.

### BRIEF DESCRIPTION OF THE DRAWINGS

FIG. 1 shows schematic representations of an exemplary embodiment for a map with faulty regions and an exemplary embodiment for a reference map.

FIG. 2 is a flow chart of an exemplary embodiment of a method according to the present invention.

### DETAILED DESCRIPTION OF EXAMPLE EMBODIMENTS

In the figures, the same or functionally identical components are provided with the same reference signs. A repeated description of such components may be omitted in order to avoid unnecessary repetition.

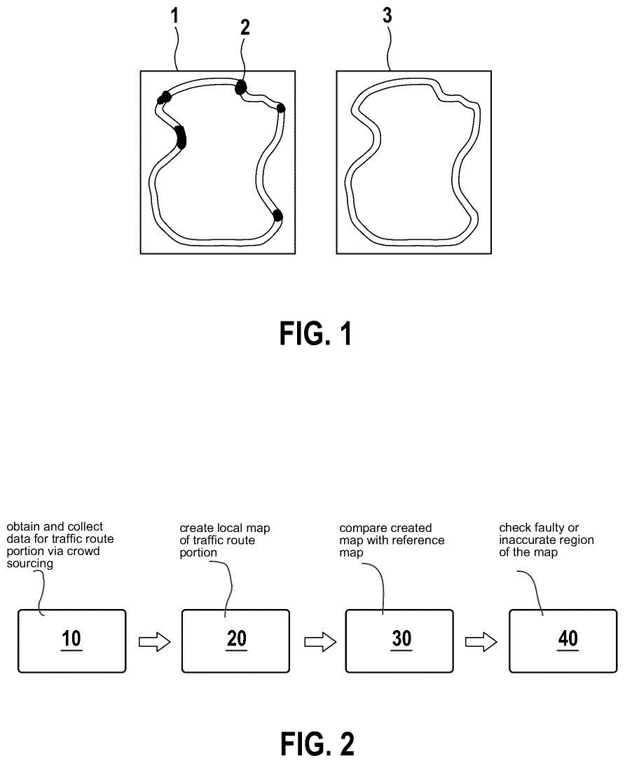

FIG. 1 shows schematic representations of an exemplary embodiment for a local map 1 with five faulty regions 2 and an exemplary embodiment for a corresponding local reference map 2. The faulty regions 2 have been ascertained by comparing the map 1 with the reference map 3.

FIG. 2 is a flowchart of an exemplary embodiment of a method according to the present invention for creating map data for the operation of an automated and/or assisting system of a vehicle or robot.

In method step 10, data are obtained and collected for a traffic route portion of a traffic route via crowd-sourcing by means of a fleet of vehicles.

In method step 20, a local map of the traffic route portion is created using the data obtained in method step 10.

In method step 30, the map created in method step 20 is compared with a reference map for the traffic route portion on an automated basis. For this purpose, the reference map was created in advance using sensor data obtained by means of a high-precision vehicle sensor system while driving along the traffic route portion.

The map is exclusively used for creating the map data on an automated basis if it arises in method step 30 that the map does not deviate from the reference map by a predefined extent with regard to at least one predefined quality measure.

Furthermore, in method step 30, a warning signal is generated and output if the map deviates from the reference map by the predefined extent with regard to the predefined quality measure. A faulty or inaccurate region of the map can then be checked manually in method step 40 before the map is used for creating the map data.

In method step 30, it can also be checked whether a quality of the map fulfills at least one additional evaluation criterion, wherein the map is then exclusively used for creating the map data on an automated basis if the quality of the map fulfills the at least one additional evaluation criterion.

What is claimed is:

1. A method for creating map data for operation of an automated and/or assisting system of a vehicle or robot, the method comprising following steps:
comprising a map for a traffic route portion of a traffic route with a reference map for the traffic route portion on an automated basis; and
exclusively using the map for creating map data on an automated basis when the map does not deviate from the reference map by a predefined extent with regard to at least one predefined quality measure.

2. The method according to claim 1, further comprising:
based on the map deviating from the reference map by the predefined extent with respect to the predefined quality measuring, generating a warning signal and outputting the warning signal.

3. The method according to claim 1, wherein the map is created using data obtained via crowd-sourcing using a fleet of vehicles.

4. The method according to claim 1, wherein the reference map is created using sensor data obtained using a high-precision vehicle sensor system while driving along the traffic route portion.

5. The method according to claim 1, wherein the map is exclusively used for creating the map data on an automated basis based on a quality of the map fulfilling at least one additional evaluation criterion.

6. A system for providing map data for the operation of an automated and/or assisting system of a vehicle or robot, the system being configured to:
compare a map for a traffic route portion of a traffic route with a reference map for the traffic route portion; and
using the map exclusively for creating the map data when the map does not deviate from the reference map by a predefined extent with regard to at least one predefined quality measure.
